(19) United States
(12) Patent Application Publication
(10) Pub. No.: US 2004/0141078 A1
(43) Pub. Date: Jul. 22, 2004

(54) Solid state imaging device and camera using the same

(75) Inventor: Takumi Yamaguchi, Kyoto-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/754,054

(22) Filed: Jan. 7, 2004

(30) Foreign Application Priority Data
Jan. 10, 2003 (JP) 2003-004855

(51) Int. Cl. H04N 5/335

(52) U.S. Cl. 348/308

(57) ABSTRACT

A solid-state imaging device includes: an imaging portion in which a plurality of unit pixels are arranged two-dimensionally; output signal lines into which pixel signals of the imaging portion are read out; a signal-transmission circuit for reading out the pixel signals of the imaging portion into the output signal lines by the output corresponding to a driving pulse; and output portions from which the signals of the output signal line are output. Pixel signals of the imaging portion are read out into the output signal lines by the output corresponding to plural groups of readout pulses S1, S11 S2, S21, S3 and S31 generated respectively based on a plurality of pixels. For reading out pixel signals of a plurality of pixels of a same color, the readout pulses of the same group are used. Since a variation in output for each color due to the readout pulse can be adjusted for each group of pixels, it is possible to use plural groups of readout pulses based on a plurality of driving pulses.

### FIELD OF THE INVENTION

The present invention relates to a solid-state imaging device in which unit pixels for photoelectrically converting incident light are arranged two-dimensionally, and a camera such as a digital still camera, a motion picture camera, and the like, or a camera system using the solid-state imaging device.

### BACKGROUND OF THE INVENTION

In a conventional solid-state imaging device used for a digital still camera, etc., pixel signals obtained from respective pixels for photoelectric conversion are transferred to and stored in a storage portion, for example, for each row, and then the pixel signals for each row are output sequentially in synchronization with readout pulses output from a horizontal shift resistor (see, for example, FIGS. 13 and 14 of JP2001-45378A).

FIG. 4 shows a configuration of a conventional MOS type solid-state imaging device 8. This solid-state imaging device 8 includes pixels 1 arranged two-dimensionally; a vertical signal-transmission circuit 2 for selecting the pixel 1 in a column direction; vertical signal lines 3 in the column direction; row memories 4 for storing pixel signals for each row; a horizontal signal-transmission circuit 5 for selecting the row memory 4; an output signal line 6 for outputting pixel signals for each row; and an output amplifier 7.

A plurality of pixels 1 are arranged in a Bayer arrangement of the three primary colors, red (R), green (G) and blue (B). Pixel signals obtained from the pixels 1 of each row are transferred to and stored in the row memories 4 for each row. The pixel signals stored in the row memories 4 are read out into the output signal line 6 sequentially in the order of the readout pulses S1, S2, S3, S4, S5 and S6 output from the horizontal signal-transmission circuit 5; and then output from the output amplifier 7.

FIGS. 5A and 5B show output waveforms from the output amplifier 7 of a conventional MOS type solid-state imaging device. As shown in FIG. 5A, the output signals of the n-th row are output so that the signals of G1 (n), B1 (n), G2 (n), B2 (n), G3 (n) and B3 (n) are output in the order in which the readout pulses S1 to S6 from the horizontal signal-transmission circuit 5 are turned on. Similarly, as shown in FIG. 5B, the output signals of the (n+1)-th row are output so that the signals of R1 (n+1), G1 (n+1), R2 (n+1), G2 (n+1), R3 (n+1) and G3 (n+1) are output sequentially from the amplifier 7.

FIG. 6 shows a specific example of the horizontal signal-transmission circuit 5 in a conventional MOS type solid-state imaging device 8. This circuit includes source followers (T12, T22, T32 and T42); bootstrap capacitors (C1, C2, C3 and C4); charging transistors (T11, T21, T31, and T41) for bootstrap capacitors; and discharging transistors (T13, T14, T23, T24, T33, T34, T43 and T44). V1 and V2 represent driving pulses; VST represents a start pulse for horizontal signal-transmission circuit; and VDD represents a VDD power supply.

When the start pulse VST is input into a gate of the charging transistor T11 for bootstrap capacitor, the bootstrap capacitor C1 is charged in the plus direction of the VDD power supply, and the source follower T12 is turned on. Thereafter, when the driving pulse V1 is input into a drain of the source follower T12, a gate of the source follower T12 is supplied with an electric potential of a potential difference between both ends of the bootstrap capacitor C1 in addition to the driving pulse V1. When the electric potential under a gate of the source follower T12 can be made to be greater than the driving pulse V1, the driving pulse V1 is output to a node N12. This output is used as a readout pulse S1 of the horizontal signal-transmission circuit.

At the same time, the voltage of the node N12 is applied to a gate of the charging transistor T21 for bootstrap capacitor of the following stage, the bootstrap capacitor C21 is charged and the source follower T22 is turned on.

Thereafter, the driving pulse V2 is input into the drain of the source follower T22, a gate of the source follower T22 is supplied with an electric potential of a potential difference between both ends of the bootstrap capacitor C2 in addition to the driving pulse V2. When the electric potential under a gate of the source follower T22 can be made to be greater than the driving pulse V2, the driving pulse V2 is output to a node N22. This output becomes the readout pulse S11 of the horizontal signal-transmission circuit.

At the same time, the voltage of the node N22 is applied to a gate of the charging transistor T31 for bootstrap capacitor of the following stage, the bootstrap capacitor C3 is charged, and the source follower T32 is turned on. At this time, the voltage of the node N22 is applied to gates of the discharging transistors T13 and T14, and the bootstrap capacitor Cl of the precedent stage is discharged.

With the repetition of such operations, a horizontal signal-transmission circuit sequentially outputs readout pulses such as S2, S21, and the like.

In the above-mentioned configuration, a first group of the readout pulses S1 and S2 correspond to the driving pulse V1; and a second group of the readout pulses S11 and S21 correspond to the driving pulse V2. Since the driving pulse to which the readout pulses S1 and S2 correspond is different from the driving pulse to which the readout pulses S11 and S21 correspond, a variation in waveform occurs between the readout pulses S1 and S2 and the readout pulses S11 and S21. When the pixel signal in the row memory 4 is readout into the output signal line 6, in order to prevent the occurrence of a variation in output due to the variation in waveform of the readout pulse, the output of the horizontal signal-transmission circuit uses only the readout pulses S1 and S2 corresponding to the driving pulse V1. Therefore, although two blocks, i.e., a circuit block for generating S1 and a circuit block for generating S11 are provided in a horizontal pixel pitch of the imaging portion, one output actually is not used as a readout pulse.

However, when a horizontal pixel pitch in the imaging portion becomes fine and the horizontal signal-transmission circuit is required to be fine, it is difficult to provide two circuit blocks for readout pulses S1 and S11 in a horizontal pixel pitch, thus hindering the effort to make the horizontal signal-transmission circuit fine. Also when a vertical pixel pitch becomes fine, it becomes difficult to make the vertical signal-transmission circuit to be fine.

### SUMMARY OF THE INVENTION

With the foregoing in mind, it is an object of the present invention to provide a solid-state imaging device allowing one circuit block of a signal-transmission circuit to be disposed in one pixel pitch, so that a signal-transmission circuit, can be made to be fine easily even in the case where a pixel pitch becomes fine. Furthermore, it is another object of the present invention to provide a camera or a camera system that makes use of such a solid-state imaging device.

The solid-state imaging device of the present invention includes an imaging portion in which a plurality of unit pixels for photoelectrically converting incident light are arranged two-dimensionally; an output signal line into which pixel signals of the imaging portion are read out; a signal-transmission circuit for reading out the pixel signals of the imaging portion into the output signal line by the output corresponding to a driving pulse; and an output portion from which the signals of the output signal line are output.

In order to overcome the above-mentioned problem, the solid-state imaging device has a configuration in which pixel signals of the imaging portion are read out into the output signal line by the output corresponding to plural groups of readout pulses generated respectively based on a plurality of the driving pulses; and a same group of the readout pulses are used for reading out pixel signals of a plurality of pixels of a same color.

### BRIEF DESCRIPTION OF THE DRAWINGS

FIG. 1 is a view showing a configuration of a MOS type solid-state imaging device according to Embodiment 1 of the present invention.

FIGS. 2A and 2B are views showing output waveforms of the output amplifier of the MOS type solid-state imaging device shown in FIG. 1.

FIG. 3 is a view showing a configuration of a MOS type solid-state imaging device according to Embodiment 2 of the present invention.

FIG. 4 is a view showing a configuration of a conventional MOS type solid-state imaging device.

FIGS. 5A and 5B are views showing output waveforms of an output amplifier of the MOS type solid-state imaging device shown in FIG. 3.

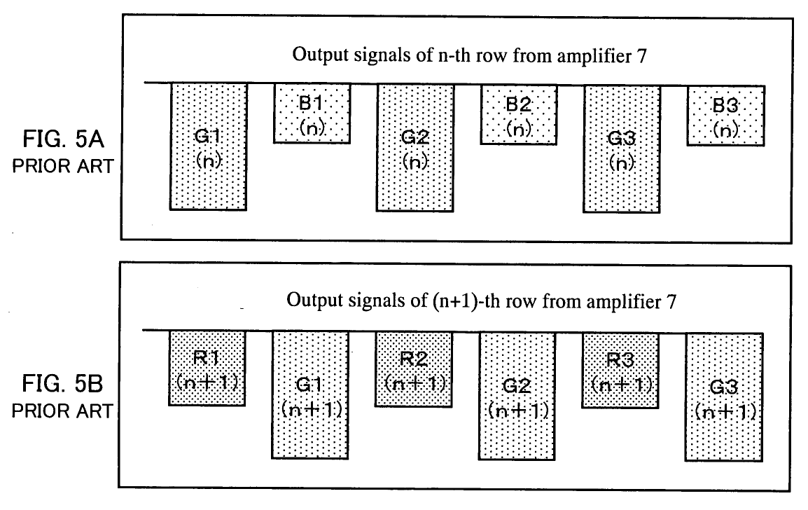

FIG. 6 is a circuit diagram showing a horizontal signal-transmission circuit of a conventional MOS type solid-state imaging device.

### DESCRIPTION OF THE PREFERRED EMBODIMENTS

According to the solid-state imaging device of the present invention, since plural groups of readout pulses generated respectively based on a plurality of driving pulses are used for reading out pixel signals, it is possible to dispose only one circuit block of a signal-transmission circuit in one pixel pitch. When the pixel pitch becomes fine, it is possible to make a signal-transmission circuit to be fine easily. Furthermore, with respect to a plurality of predetermined pixels with one color, readout pulses of one same group are assigned. Therefore, when a variation in output for each color occurs due to a variation in waveforms of the readout pulses, the final output of the pixels can be adjusted independently.

The solid-state imaging device according to the present invention may have a configuration in which a pixel signal with a different color is read out into the same output signal line by using a different group of the readout pulses.

The solid-state imaging device according to the present invention may include plural sets of the output signal lines and the output portions. In the configuration, pixel signals of a plurality of pixels with a first color in the imaging portion are read out into a first of the output signal lines by the output corresponding to a first of the readout pulses; and pixel signals of a plurality of pixels with a second color in the imaging portion are read out into the first output signal lines or a second of the output signal lines by the output corresponding to a second of the readout pulses.

The solid-state imaging device of the present invention may have another configuration as follows. That is to say, the solid-state imaging device includes an imaging portion in which a plurality of unit pixels for photoelectrically converting incident light are arranged two-dimensionally; a vertical signal line into which pixel signals for each row of the pixels of the imaging portion are read out; a vertical signal-transmission circuit for reading out the pixel signals of the imaging portion into the vertical signal line by the output corresponding to a driving pulse; an output signal line into which pixel signals for each row, which are read out into the vertical signal line, are read out; a horizontal signal-transmission circuit for reading out the pixel signal for each row, which are read out into the vertical signal line, into the output signal line by the output corresponding to the driving pulse; and an output portion from which the signals of the output signal line are output. The solid-state imaging device includes plural sets of the output signal lines and the output portions. Pixel signals of the imaging portion are read out by the output corresponding to plural groups of readout pulses generated respectively based on a plurality of the driving pulses. Pixel signals of a plurality of pixels with a first color in one same row are read out into a first of the output signal lines by the output corresponding to a first readout pulse generated by the horizontal transmission circuit based on a first of the driving pulses. A pixel signal of a plurality of pixels with a second color in the same row is read out into the first output signal line or a second of the output signal lines by the output corresponding to a second readout pulse generated by the horizontal transmission circuit based on a second of the driving pulses.

According to this configuration, in the same row, since one readout pulse and one output signal line from the signal-transmission circuit are assigned to a plurality of specific pixels of one color, even if a variation in output for each color occurs due to a variation in waveforms of the readout pulses, the final output of the specific pixels can be adjusted independently for each color. Therefore, as to the pixels of the specific colors, it is possible to dispose only one circuit block of the horizontal signal-transmission circuit in one horizontal pixel pitch. Thus, even if the pixel pitch becomes fine, it is possible to make the horizontal signal-transmission circuit to be fine easily.

In the above-mentioned configuration, it is preferable that pixel signals of all pixels with the first color in one same row are read out into the first output signal line by the output corresponding to the first readout pulse; and pixel signals of all pixels with the second color in the same row are read out respectively into the first output signal line or the second output signal line by the output corresponding to the second readout pulse. Thus, even if a variation in output for each color occurs due to a variation in waveforms of the readout pulses, the final output for each color can be adjusted independently. Therefore, it is possible to dispose only one circuit block of the horizontal signal-transmission circuit in one horizontal pixel pitch. Even if the pixel pitch becomes fine, it is possible to make all the portions of the horizontal signal-transmission circuit to be fine easily.

The solid-state imaging device may have a still further configuration. That is to say, the solid-state imaging device includes an imaging portion in which a plurality of unit pixels for photoelectrically converting incident light are arranged two-dimensionally; a vertical signal line into which pixel signals for each row of the pixels of the imaging portion are read out; a vertical signal-transmission circuit for reading out the pixel signals of the imaging portion into the vertical signal lines by the output corresponding to a driving pulse; an output signal line into which pixel signals for each row, which are read out into the vertical signal lines, are read out; a horizontal signal-transmission circuit for reading out the pixel signals for each row, which are read out into the vertical signal lines, into the output signal lines by the output corresponding to the driving pulse; and an output portion from which the signals of the output signal line are output. Pixel signals of the imaging portion are read out using the output corresponding to plural groups of read-pulses generated respectively based on a plurality of the driving pulses. With respect to a plurality of rows of pixels having a same color arrangement in a first color arrangement, pixel signals are read out into the vertical signal line by the output corresponding to a third readout pulse generated by the vertical signal-transmission circuit based on a first of the driving pulses; and with respect to a plurality of rows of pixels having a same color arrangement in a second color arrangement, pixel signals are read out into the vertical signal line by the output corresponding to a fourth readout pulse generated by the vertical signal-transmission circuit based on a second of the driving pulses.

According to the this configuration, when the pixel signals of specific two or more of the arranged rows in which the color arrangement is the same in the imaging portion are read out into the horizontal signal lines, they can be read out by the output corresponding to the same readout pulse of the vertical transmission circuit. Even if a variation in output for each row having the different color arrangement occurs due to a variation in waveforms of the readout pulses, the final output can be adjusted independently for each row of the specific color arrangement. Therefore, it is possible to dispose only one circuit block of the signal-transmission circuit in one vertical pixel pitch. Thus, even if the vertical pixel pitch becomes fine, it is possible to make the signal-transmission circuit to be fine easily.

In the above-mentioned configuration, it is preferable that with respect to all the rows of the first color arrangement, pixel signals are read out respectively into the vertical signal line by the output corresponding to the third readout pulse; and with respect to all the rows of the second color arrangement, pixel signals are read out respectively into the vertical signal lines by the output corresponding to the fourth readout pulse. Thus, even if a variation in output for each row having the different arrangement occurs due to a variation in waveforms of the readout pulses, the final output can be adjusted independently for each row of the same arrangement. Therefore, it is possible to dispose only one circuit block of the signal-transmission circuit in one vertical pixel pitch. Thus, even if the pixel pitch becomes fine, it is possible to make all the portions in the signal-transmission circuit to be fine easily.

The above-mentioned configuration is described with respect to the case where pixel signals are read out for each row. However, as mentioned below, also in the case where pixel signals are read out for each column, the present invention can also be applied.

That is to say, the solid-state imaging device of the present invention includes: an imaging portion in which a plurality of unit pixels for photoelectrically converting incident light are arranged two-dimensionally; a horizontal signal line into which pixel signals for each column of the pixels of the imaging portion are read out; a horizontal signal-transmission circuit for reading out the pixel signals of the imaging portion into the horizontal signal lines by the output corresponding to a driving pulse; an output signal line into which pixel signals for each column, which are read out into the horizontal signal lines, are read out; a vertical signal-transmission circuit for reading out the pixel signals for each column, which are read out into the horizontal signal lines, into the output signal line by the output corresponding to the driving pulse; and an output portion from which the signals of the output signal line are output. The solid-state imaging device includes plural sets of the output signal lines and the output portions. Pixel signals of the imaging portion are read out into plural groups of readout pulses generated respectively based on a plurality of the driving pulses; and pixel signals of a plurality of pixels with a first color in one particular column are read out into a first of the output signal lines by the output corresponding to a first of the readout pulse generated by the vertical signal-transmission circuit based on a first of the driving pulses; and pixel signals of a plurality of pixels with a second color in the same column are read out into the first output signal line or a second of the output signal lines by the output corresponding to a second readout pulse generated by the vertical signal-transmission circuit based on a second of the driving pulses.

According to this configuration, in the same column, one readout pulse and one output signal line of the signal-transmission circuit are assigned to a plurality of specific pixel signals of one color. Therefore, even if a variation in output for each color occurs due to a variation in waveforms of the readout pulses, the final output can be adjusted independently. Therefore, as to the specific pixels, it is possible to dispose only one circuit block of the signal-transmission circuit in one vertical pixel pitch. Thus, even if the pixel pitch becomes fine, it is possible to make the signal-transmission circuit to be fine easily.

In the above-mentioned configuration, it is preferable that pixel signals of all pixels with the first color in one particular column are read out respectively into the first output signal line by the output corresponding to the first readout pulse; and pixel signals of all pixels with the second color in the same column are read out respectively into the first output signal line or the second output signal line by the output corresponding to the second readout pulse.

Thus, even if a variation in output for each color occurs due to a variation in waveforms of the readout pulses, the final output can be adjusted independently for each color. Therefore, even if the pixel pitch becomes fine, only one circuit block may be provided in one vertical pixel pitch, and thus it becomes possible to make all the portions of the signal-transmission circuit to be fine.

Furthermore, the solid-state imaging device according to the present invention may be configured as follows. That is to say, the solid-state imaging device includes an imaging portion in which a plurality of unit pixels for photoelectrically converting incident light are arranged two-dimensionally; a horizontal signal line into which pixel signals for each column of the pixels of the imaging portion are read out; a horizontal signal-transmission circuit for reading out the pixel signals of the imaging portion into the horizontal signal lines by the output corresponding to a driving pulse; an output signal line into which pixel signals for each column, which are read out into the horizontal signal lines, are read out; a vertical signal-transmission circuit for reading out the pixel signals for each column, which are read out into the horizontal signal lines, into the output signal lines by the output corresponding to the driving pulse; and an output portion from which the signals of the output signal line are output. Pixel signals of the imaging portion are read out by the output based on plural groups of readout pulses generated respectively based on a plurality of the driving pulses. With respect to the pixels of a plurality of columns of a first color arrangement, pixel signals are read out into the horizontal signal line by the output corresponding to a third readout pulse generated by the horizontal signal-transmission circuit based on a first of the driving pulses; and with respect to the pixels of a plurality of columns of a second color arrangement, pixel signals are read out into the horizontal signal line by the output corresponding to a fourth readout pulse generated by the horizontal signal-transmission circuit based on a second of the driving pulses.

According to the above-mentioned configuration, when two or more of specific columns in which the arrangement in the imaging portion is the same are read out, they can be read out by the output corresponding to the readout pulse of the same horizontal signal-transmission circuit. Thus, even if a variation in output for each column having a different arrangement occurs, the final output can be adjusted independently for each column having the same specific arrangement. Therefore, it is possible to provide a portion in which it is possible to dispose only one circuit block of the signal-transmission circuit in one horizontal pixel pitch, so that even if the horizontal pixel pitch becomes fine, it is possible to make the horizontal signal-transmission circuit to be fine easily.

In the configuration, it is preferable that with respect to all the columns of the first color arrangement, pixel signals are read out respectively into the horizontal signal lines by the output corresponding to the third readout pulse; and with respect to all the columns of the second color arrangement, pixel signals are read out respectively into the horizontal signal lines by the output corresponding to the fourth readout pulse.

Thus, even if a variation in output for each column having a different arrangement occurs due to a variation in waveforms of the readout pulses, the final output can be adjusted independently for each column of the same arrangement. Therefore, it is possible to dispose only one circuit block of the signal-transmission circuit in one vertical pixel pitch. Thus, even if the pixel pitch becomes fine, it is possible to make all the portions in the signal-transmission circuit to be fine easily.

It is possible to configure a camera or a camera system including the solid-state imaging device having any one of the above-mentioned configurations.

Hereinafter, with reference to drawings, the embodiment of the present invention will be described with reference to drawings.

(Embodiment 1)

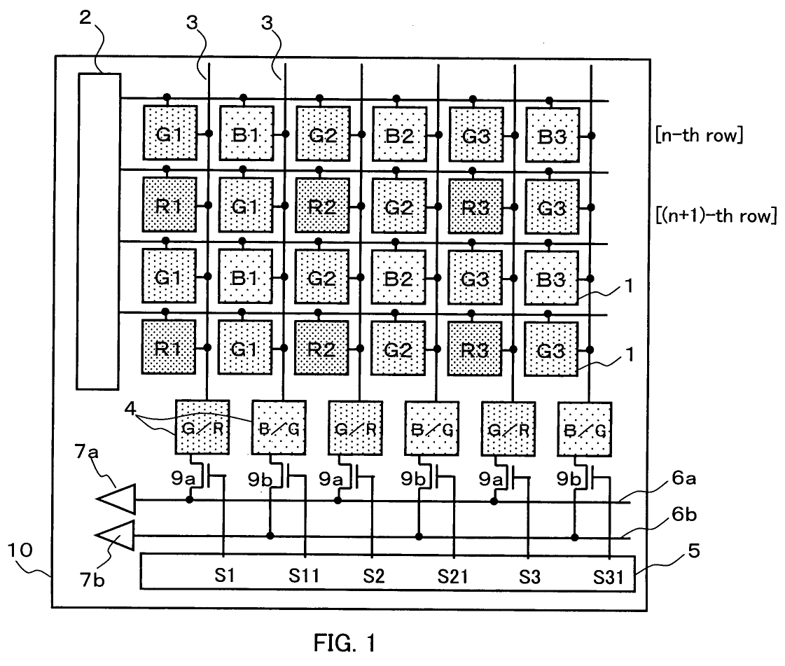

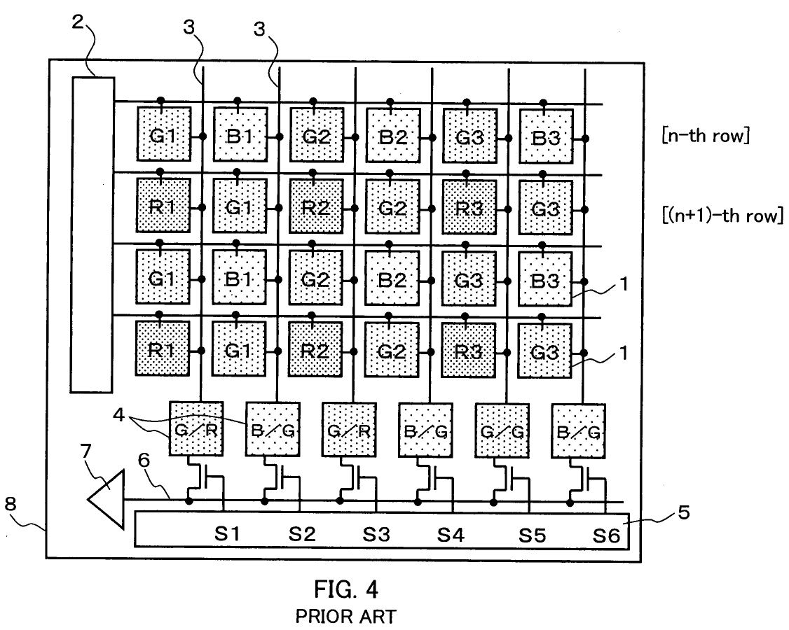

FIG. 1 shows a configuration of a MOS type solid-state imaging device 10 according to Embodiment 1 of the present invention. To the same elements as those of the conventional example shown in FIG. 4, the same reference numbers are given and the explanations therefor are not repeated herein.

The configuration of the MOS type solid-state imaging device 10 is different from that of the conventional example in that two output signal lines 6a and 6b are provided for reading out pixel signals stored in a row memory 4 and in the way of using the readout pulse output from the horizontal signal-transmission circuit 5. To the output signal lines 6a and 6b, output amplifiers 7a and 7b are connected, respectively. To the output signal line 6a, storage position (G/R) of the row memory 4 is connected via a readout switch 9a. To the output signal line 6b, storage position (B/G) is connected via a readout switch 9b.

A plurality of pixels 1 are arranged in a Bayer arrangement of the three primary colors, red (R), green (G) and blue (B), which is the same configuration as that of the conventional example. After pixel signals for each row are transferred from the pixel 1 to the row memory 4, they are read out into the output signal line 6a corresponding to a first group of the readout pulses S1, S2 and S3 from the horizontal signal-transmission circuit 5, and read out into the output signal line 6b corresponding to a second group of the readout pulses S11, S21 and S31. Therefore, different colors in the same row stored in the row memory 4 are read out independently into the output signal lines 6a and 6b. For example, in the case of the n-th row, green (G) signal stored in the row memory 4 is read out into the output signal line 6a, and blue (B) signal is read out into the output signal line 6b. Thus, to the output signal lines 6a and 6b, the signals of the same color are successively read out from the row memory 4, and different colors are output to the output amplifiers 7a and 7b, respectively.

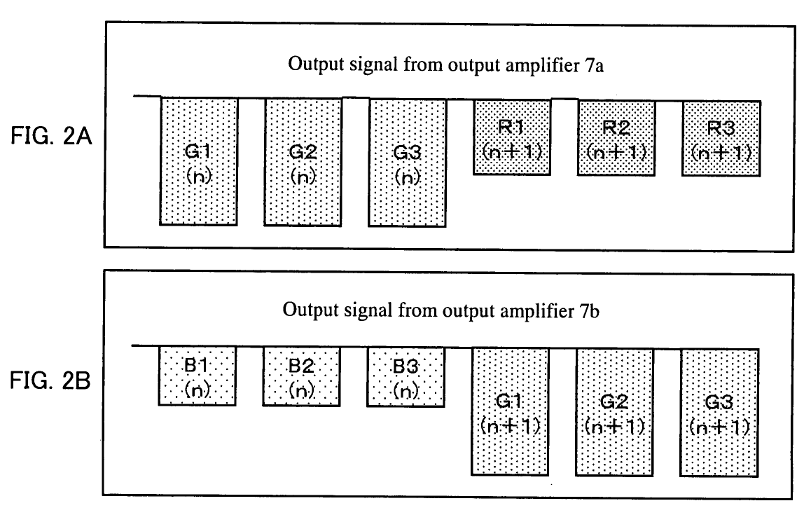

FIGS. 2A and 2B show output waveforms in the output amplifier of the above-mentioned MOS type solid-state imaging device 10. As pixel signals of the n-th row, from the output amplifier 7a, signals of G1 (n), G2 (n) and G3 (n) are output in this order as shown in FIG. 2A; and from the output amplifier 7b, signals of B1 (n), B2 (n), and B3 (n) are output in this order as shown in FIG. 2B. Furthermore, as pixel signals of the (n+1)-th row, from the output amplifier 7a, signals of R1 (n+1), R2 (n+1) and R3 (n+1) are output in this order as shown in FIG. 2A; and from the output amplifier 7b, signals of G1 (n+1), G2 (n+1), and G3 (n+1) are output in this order as shown in FIG. 2B. Thus, as each of the output signals from the output amplifiers 7a and 7b, signals of the same color in the same row are successively output.

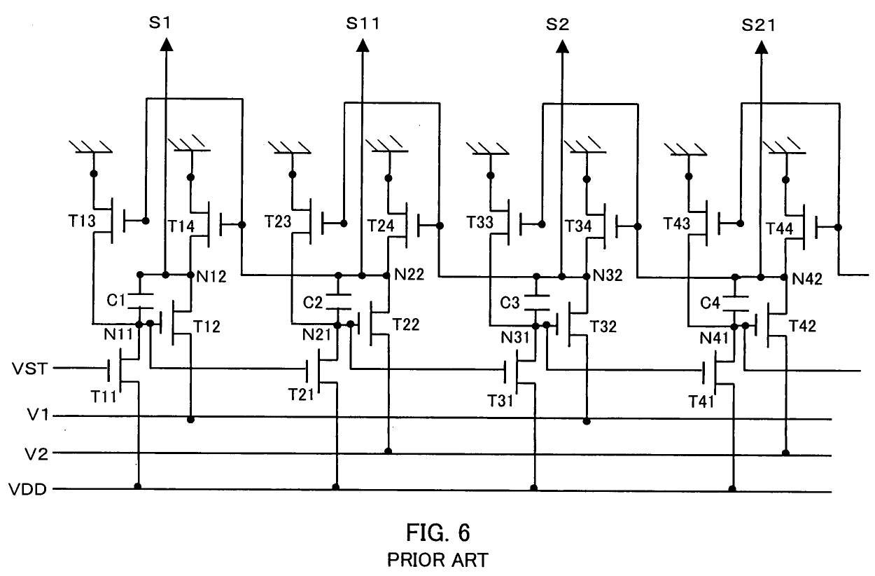

The configuration and the operation of the horizontal signal-transmission circuit 5 of the above-mentioned MOS type solid-state imaging device 10 are the same as those in the conventional circuit shown in FIG. 6. The configuration and the operation of the horizontal signal-transmission circuit 5 of the above-mentioned MOS type solid-state imaging device 10 are different from those of the conventional example in that all of the pulses respectively output from the nodes N12, N22, N32, and N42 are used. That is to say, the pulse corresponding to the driving pulse V2, which was not used in the conventional example, is used as readout pulse S11 and S21 of the horizontal signal-transmission circuit. Therefore, the readout pulses S1 and S2 are supplied to the readout switch 9a in FIG. 1 and the readout pulses S11 and S21 are supplied to the readout switch 9b.

In the configuration of this embodiment, the readout pulses S1, S2 and S3 shown in FIG. 1 correspond to the driving pulse V1; and the readout pulses S11, S21 and S31 correspond to the driving pulse V2. The signals of the same color are read out from the row memory 4 to the output signal line 6a by the readout pulses S1, S2 and S3, and then output from the output amplifier 7a. Furthermore, the signals of the same color (which are different from those read out into the output signal line 6a) are read out from the row memory 4 into the output signal line 6b by the readout pulses S11, S21 and S31, and then output from the output amplifier 7a.

According to this configuration, even if there is a variation of the signals between the output signal lines 6a and 6b due to the effect of a variation in waveforms in the driving pulses V1 and V2, as to the colors in the same row, a signal variation between the output amplifiers 7a and 7b can finally be adjusted. Therefore, as an output of signal-transmission circuit, it is possible to use the output corresponding to both of the driving pulses V1 and V2. Therefore, within the horizontal pixel pitch of the imaging portion, one circuit block of the signal-transmission circuit (for example, only a circuit block for the readout pulse S1) may be disposed. Even if the horizontal pixel pitch of the imaging portion becomes fine, it is possible to make the horizontal signal-transmission circuit to be fine easily.

Furthermore, the circuit of this configuration may be used for a vertical signal-transmission circuit as follows. By using the output corresponding to V1 for the row arrangement of green (G) and blue (B) and using the output corresponding to V2 for the row arrangement of red (R) and green (G), it is possible to make the vertical signal-transmission circuit to be fine easily as in the case of the horizontal signal-transmission circuit even if the vertical pixel pitch becomes fine.

In this embodiment, in each row, all colors are read out into the same horizontal signal line, by which the effect is maximum. However, even in the case where at least two of the same signals are read out into the same horizontal signal line, it is possible to obtain an effect for facilitating an increase in fineness.

In this embodiment, different colors of each row are read out into different horizontal signal lines. In this case, since output for each color can be classified inside the solid-state imaging device, it is possible to reduce circuits for selecting colors in the external circuit of the solid-state imaging device. Therefore, this configuration can exhibit the greatest effect in downsizing the external circuit of the solid-state imaging device. On the other hand, pixel signals of at least two kinds of different colors of each row may be read out into the same horizontal line at the different driving pulses. In such a case, a variation is corrected for each different color in the external circuit of the solid-state imaging device. As a result, the same effect as mentioned above can be obtained. That is to say, it is possible to use all the pulses output from each block of the signal-transmission circuit, and it is possible to dispose only one circuit block in the pixel pitch of the imaging portion. Therefore, the signal-transmission circuit can be made to be fine easily.

(Embodiment 2)

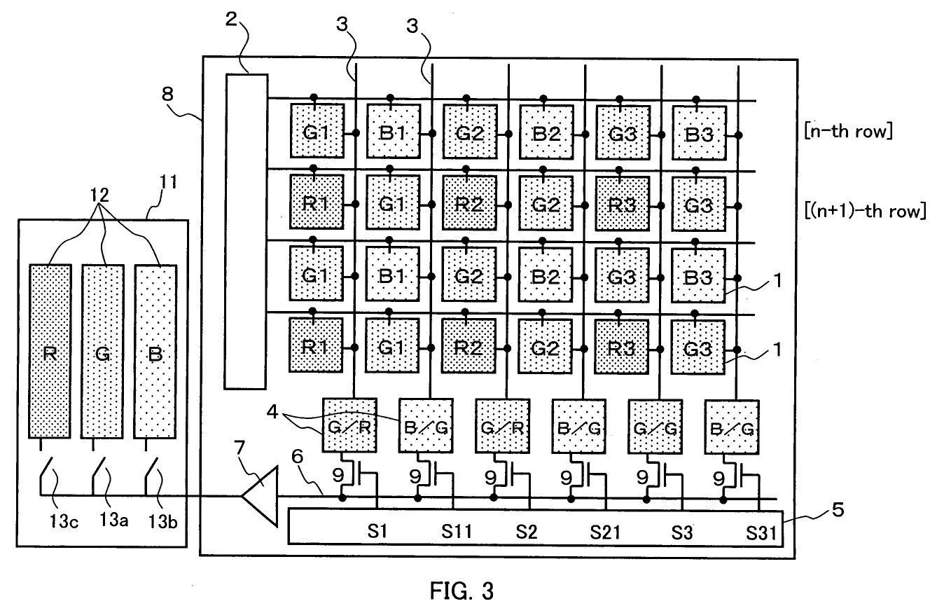

FIG. 3 shows a configuration of the MOS type solid-stage imaging device 10 according to Embodiment 2 of the present invention. To the same elements as those of the conventional example shown in FIG. 4, the same reference numbers are given and the explanations therefor are not repeated herein. This embodiment is the simplest configuration in a case where pixel signals of at least two kinds of colors are read out into the same horizontal signal line by the readout pulses of the groups based on the respective driving pulses being different for each color.

In this embodiment, similar to FIG. 4 of the conventional example, all pixel signals are read out into one output signal line 6. However, with respect to each read-out switch 9, all readout pulses S1, S11, S2, S21, S3 and S31 generated by the horizontal signal-transmission circuit 5 are supplied, respectively. Thus, pixel signals of at least two kinds of colors in each row are read out into the common output signal line 6 by the different groups of the readout pulses for each color, then classified for each color in the external circuit of the solid-state-imaging device and a variation due to the driving pulse is corrected. In order to do so, for example, as shown in FIG. 3, output from the output amplifier 7 is supplied to an external circuit 11. The external circuit 11 includes an external memory 12 in which pixel signals output from the solid-state imaging device 8 are stored separately in respective colors, and color selection switches 13a to 13c. With respect to the pixel signals stored separately in respective colors in the external memory 12, the above-mentioned correction is carried out.

In the above-mentioned embodiments, signals of each row are input into the row memory, and read out in the horizontal signal lines. However, the present invention also can be applied in the case where signals of each column are input into a column memory and read out into the vertical output signal lines.

Furthermore, the above-mentioned embodiments mention an example in which color filters of primary colors of R, G and B are used. However, when color filters of complementary colors such as cyan (Cy), magenta (Mg), yellow (Ye), green (G), etc. are used, the present invention also can be applied.

Furthermore, the above-mentioned embodiments mention the case where the output from the signal-transmission circuit directly corresponds to the readout pulse. However, the present invention can be applied in a case where the output from the signal-transmission circuit is a different pulse output based on the readout pulse, for example, another readout pulse generated from the multiplexer to which the readout pulse is supplied.

Furthermore, in the above-mentioned embodiment, an optically black pixel (optical black) is not shown. However, if a region of an optically black pixel is present in the vicinity of or inside the imaging portion, and the signals of the optically black pixels other than the color signals are read out, the present invention also can be applied.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A solid-state imaging device, comprising:
an imaging portion in which a plurality of unit pixels for photoelectrically converting incident light are arranged two-dimensionally;
an output signal line into which pixel signals of the imaging portion are read out;
a signal-transmission circuit for reading out the pixel signals of the imaging portion into the output signal line by the output corresponding to a driving pulse; and
an output portion from which the signals of the output signal line are output,
wherein pixel signals of the imaging portion are read out into the output signal line by the output corresponding to plural groups of readout pulses generated respectively based on a plurality of the driving pulses; and
a same group of the readout pulses are used for reading out pixel signals of a plurality of pixels of a same color.

2. The solid-state imaging device according to claim 1, wherein a pixel signal with a different color is read out into the same output signal line by using a different group of the readout pulses.

3. The solid-state imaging device according to claim 1, comprising plural sets of the output signal lines and the output portions;
wherein pixel signals of a plurality of pixels with a first color in the imaging portion are read out into a first of the output signal lines by the output corresponding to a first of the readout pulses; and pixel signals of a plurality of pixels with a second color in the imaging portion are read out into the first output signal lines or a second of the output signal lines by the output corresponding to a second of the readout pulses.

4. A solid-state imaging device, comprising:
an imaging portion in which a plurality of unit pixels for photoelectrically converting incident light are arranged two-dimensionally;
a vertical signal line into which pixel signals for each row of the pixels of the imaging portion are read out;
a vertical signal-transmission circuit for reading out the pixel signals of the imaging portion into the vertical signal line by the output corresponding to a driving pulse;
an output signal line into which pixel signals for each row, which are read out into the vertical signal line, are read out;
a horizontal signal-transmission circuit for reading out the pixel signal for each row, which are read out into the vertical signal line, into the output signal line by the output corresponding to the driving pulse; and
an output portion from which the signals of the output signal line are output,
wherein the solid-state imaging device includes plural sets of the output signal lines and the output portions;
pixel signals of the imaging portion are read out by the output corresponding to plural groups of readout pulses generated respectively based on a plurality of the driving pulses; and
pixel signals of a plurality of pixels with a first color in one particular row are read out into a first of the output signal lines by the output corresponding to a first readout pulse generated by the horizontal transmission circuit based on a first of the driving pulses; and a pixel signal of a plurality of pixels with a second color in the same row is read out into the first output signal line or a second of the output signal lines by the output corresponding to a second readout pulse generated by the horizontal transmission circuit based on a second of the driving pulses.

5. The solid-state imaging device according to claim 4, wherein pixel signals of all pixels with the first color in one particular row are read out into the first output signal line by the output corresponding to the first readout pulse; and pixel signals of all pixels with the second color in the same row are read out respectively into the first output signal line or the second output signal line by the output corresponding to the second readout pulse.

6. A solid-state imaging device, comprising:
an imaging portion in which a plurality of unit pixels for photoelectrically converting incident light are arranged two-dimensionally;
a vertical signal line into which pixel signals for each row of the pixels of the imaging portion are read out;
a vertical signal-transmission circuit for reading out the pixel signals of the imaging portion into the vertical signal lines by the output corresponding to a driving pulse;
an output signal line into which pixel signals for each row, which are read out into the vertical signal lines, are read out;
a horizontal signal-transmission circuit for reading out the pixel signals for each row, which are read out into the vertical signal lines, into the output signal lines by the output corresponding to the driving pulse; and
an output portion from which the signals of the output signal line are output,
wherein pixel signals of the imaging portion are read out using the output corresponding to plural groups of read-pulses generated respectively based on a plurality of the driving pulses;
with respect to a plurality of rows of pixels having a first color arrangement, pixel signals are read out into the vertical signal line by the output corresponding to a third readout pulse generated by the vertical signal-transmission circuit based on a first of the driving pulses; and with respect to a plurality of rows of pixels having a second color arrangement, pixel signals are read out into the vertical signal line by the output corresponding to a fourth readout pulse generated by the vertical signal-transmission circuit based on a second of the driving pulses.

7. The solid-state imaging device according to claim 6, wherein with respect to all the rows of the first color arrangement, pixel signals are read out respectively into the vertical signal line by the output corresponding to the third readout pulse; and with respect to all the rows of the second color arrangement, pixel signals are read out respectively into the vertical signal lines by the output corresponding to the fourth readout pulse.

8. A solid-state imaging device, comprising:
an imaging portion in which a plurality of unit pixels for photoelectrically converting incident light are arranged two-dimensionally;
a horizontal signal line into which pixel signals for each column of the pixels of the imaging portion are read out;
a horizontal signal-transmission circuit for reading out the pixel signals of the imaging portion into the horizontal signal lines by the output corresponding to a driving pulse;
an output signal line into which pixel signals for each column, which are read out into the horizontal signal lines, are read out;
a vertical signal-transmission circuit for reading out the pixel signals for each column, which are read out into the horizontal signal lines, into the output signal line by the output corresponding to the driving pulse; and
an output portion from which the signals of the output signal line are output,
wherein the solid-state imaging device includes plural sets of the output signal lines and the output portions;
pixel signals of the imaging portion are read out by the output corresponding to plural groups of readout pulses generated respectively based on a plurality of the driving pulses;
pixel signals of a plurality of pixels with a first color in one same column are read out into a first of the output signal lines by the output corresponding to a first of the readout pulse generated by the vertical signal-transmission circuit based on a first of the driving pulses; and pixel signals of a plurality of pixels with a second color in the same column are read out into the first output signal line or a second of the output signal lines by the output corresponding to a second readout pulse generated by the vertical signal-transmission circuit based on a second of the driving pulses.

9. The solid-state imaging device according to claim 8, wherein pixel signals of all pixels with the first color in one particular column are read out respectively into the first output signal line by the output corresponding to the first readout pulse; and pixel signals of all pixels with the second color in the same column are read out respectively into the first output signal line or the second output signal line by the output corresponding to the second readout pulse.

10. A solid-state imaging device, comprising:
an imaging portion in which a plurality of unit pixels for photoelectrically converting incident light are arranged two-dimensionally;
a horizontal signal line into which pixel signals for each column of the pixels of the imaging portion are read out;
a horizontal signal-transmission circuit for reading out the pixel signals of the imaging portion into the horizontal signal lines by the output corresponding to a driving pulse;
an output signal line into which pixel signals for each column, which are read out into the horizontal signal lines, are read out;
a vertical signal-transmission circuit for reading out the pixel signals for each column, which are read out into the horizontal signal lines, into the output signal lines by the output corresponding to the driving pulse; and
an output portion from which the signals of the output signal line are output,
wherein pixel signals of the imaging portion are read out by the output based on plural groups of readout pulses generated respectively based on a plurality of the driving pulses;
with respect to the pixels of a plurality of columns of a first color arrangement, pixel signals are read out into the horizontal signal line by the output corresponding to a third readout pulse generated by the horizontal signal-transmission circuit based on a first of the driving pulses; and with respect to the pixels of a plurality of columns of a second color arrangement, pixel signals are read out into the horizontal signal line by the output corresponding to a fourth readout pulse generated by the horizontal signal-transmission circuit based on a second of the driving pulses.

11. The solid-state imaging device according to claim 10, wherein with respect to all the columns of the first color arrangement, pixel signals are read out respectively into the horizontal signal lines by the output corresponding to the third readout pulse; and with respect to all the columns of the second color arrangement, pixel signals are read out respectively into the horizontal signal lines by the output corresponding to the fourth readout pulse.

12. A camera comprising a solid-state imaging device according to any one of claims 1 to 11.
